(19) United States
(12) Patent Application Publication
(10) Pub. No.: US 2007/0027936 A1
(43) Pub. Date: Feb. 1, 2007

(54) Determining changes made to a source file to transmit to a target location providing a mirror copy of the source file

(76) Inventors: Christopher John Stakutis, Concord, MA (US); Kevin Michael Stearns, Maynard, MA (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(21) Appl. No.: 11/193,281

(22) Filed: Jul. 28, 2005

(51) Int. Cl. G06F 17/30

(52) U.S. Cl. 707/204

(57) ABSTRACT

Provided are a method, system, and program for determining changes made to a source file to transmit to a target location providing a mirror copy of the source file. An operation to modify a source file at a source location is detected, wherein a target file at a target location includes a copy of a version of the source file. A base copy of the source file is created. The operation to modify the source file after creating the base copy is executed. Differences are determined between the source file and the base copy of the file. The determined differences are transmitted to the target location, wherein an aggregation of the target file and the transmitted determined differences comprises the modified source file.

### BACKGROUND OF THE INVENTION

1. Field of the Invention

The present invention relates to a method, system, and program for determining changes made to a source file to apply to transmit to a target location providing a mirror copy of the source file.

2. Description of the Related Art

Backup programs backup data at a computer system to a backup storage device, which may comprise a local storage device or remote storage device. In certain backup environments, backup agents are installed on both a source and target systems. To determine if changes need to be applied to the target file, the source and target backup agents each calculate checksum codes for segments of the file and exchange the checksum codes. If the checksum codes for different file sections differ, then the data in the source file having different data than the target as identified by the different checksum codes needs to be transferred to the target backup agent to apply to the target file. This type of system allows only the changed data to be transferred without having to transfer the entire file, but requires the installation of separate agents. Further, the calculation of the checksums can be computationally expensive.

In other backup environments, there is only one backup program and the backup program keeps track of changed source files and then during synchronization copies the changed source files to the target site to replace the target file. This-type of backup environment avoids the need for separate source and target backup agents and checksum calculations for sections of the file, but requires that the entire modified source file be transferred even though only a small part of the source file may have changed.

### SUMMARY

Provided are a method, system, and program for determining changes made to a source file to transmit to a target location providing a mirror copy of the source file. An operation to modify a source file at a source location is detected, wherein a target file at a target location includes a copy of a version of the source file. A base copy of the source file is created. The operation to modify the source file after creating the base copy is executed. Differences are determined between the source file and the base copy of the file. The determined differences are transmitted to the target location, wherein an aggregation of the target file and the transmitted determined differences comprises the modified source file.

### BRIEF DESCRIPTION OF THE DRAWINGS

FIG. 1 illustrates of an embodiment of a computing environment.

FIG. 2 illustrates an embodiment of backup settings used by a backup program.

FIG. 3 illustrates an embodiment of information maintained with a delta file indicating changes to a source file.

FIG. 4 illustrates an embodiment of operations performed to synchronize source files with target files.

FIG. 5 illustrates an embodiment of operations to maintain information on changes to a source file.

FIGS. 6 and 7 illustrate embodiments of operations performed by a backup program to transmit changes to source files to target storage.

### DETAILED DESCRIPTION

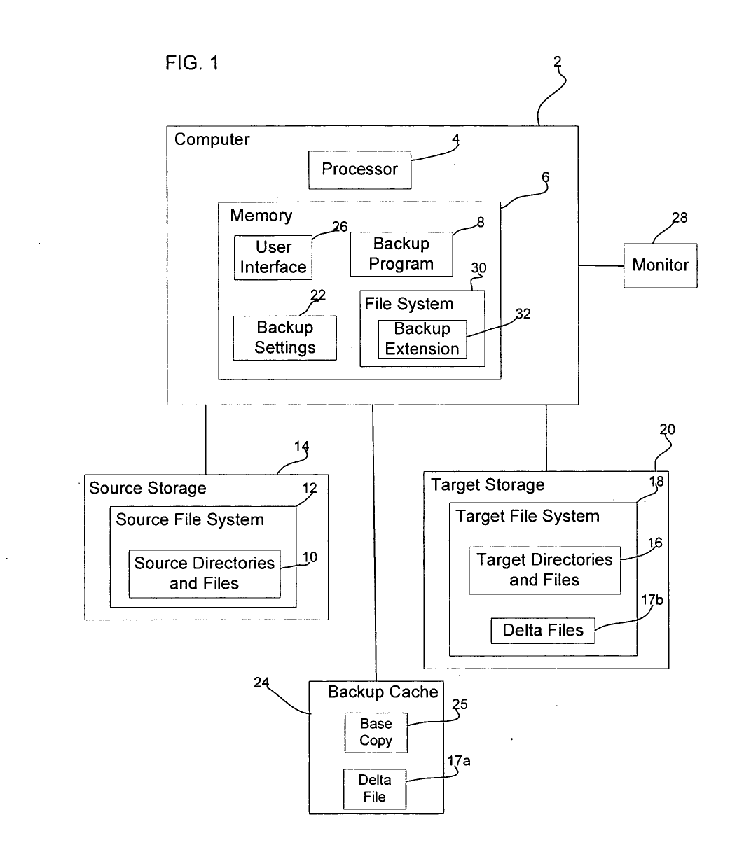

FIG. 1 illustrates a computing environment in which embodiments are implemented. A computer 2 includes a processor 4 and a memory 6 comprised of one or more memory devices including the programs and code executed by the processor 4. A backup program 8 executing in the memory 6 transfers source directories and files 10 in a source file system 12 in a source storage 14 to target directories and files 16 replicating the source directories and files 10 in a target file system 18 in a target storage 20. In one embodiment, the target directories 16 may include delta files 17b indicating the differences between a modified source file and the base copy 25, such that the application of the changes indicated in the delta file 17b to the corresponding target file for the source file for which the delta file 17a was generated comprises the modified source file. The target storage 20 may maintain multiple delta files 17b for a single target file, such that application of all the changes indicated in the multiple delta files to the target file in the order in which the changes were made makes the target file identical to the modified source file. Moreover, by maintaining multiple delta files having incremental changes to the source file, the backup program 8 can reconstruct the content of the source file at different points-in-time as represented by the point-in-time at which the different delta files 17b for a single target file were generated. For instance, to obtain the content of the source file at a point of time as of the time of creation of one selected delta file 17b, the backup program 8 may apply to the source file the modifications indicated in all delta files earlier in time to the selected delta file and the modifications indicated in the selected delta file in the order in which those modifications were made, from earliest to most current.

The backup program 8 is controlled by backup settings 22, including default settings and settings configured by a user of the backup program 8. The backup program 8 may generate a user interface 26 rendered on a computer monitor 28 in which the user may enter backup settings 22 to control the backup operations of the backup program 8.

A backup cache 24 is used to maintain a base copy 25 comprising a copy of a source file before modifications are made to that source file. In one embodiment, the backup cache 24 further includes delta files 17a for modified source files that indicate changes between a source file and the base copy 25 for the source file. The backup cache 24 may be implemented in the same device as the source storage 14 or in a separate storage device. The source storage 14, target storage 20, and backup cache 24 may be implemented in separate storage devices or in a same storage device or system. The memory 6 may further include a file system 30 that implements a hierarchical file system 12 to maintain and store user and system data. A backup extension 32 may be integrated with the file system 30 code to intercept modifications to source files in the file system 12. The backup extension 32 intercepts file system 30 operations to modify a source file to determine whether a base copy 25 needs to be created.

In certain embodiments, the file system 30 and backup extension 32 may operate at a high priority, such as by executing in a kernel mode of the operating system. The backup extension 32 may be installed to modify the file system 30 code when installing the backup program 8. The backup program 8 may operate in a user mode or space, as opposed to kernel mode, to perform backup related operations, such as synchronization, that do not involve intercepting file system operations, such as writes.

The storages 14 and 20 may be implemented in storage devices known in the art, such as one hard disk drive, a plurality of interconnected hard disk drives configured as Direct Access Storage Device (DASD), Redundant Array of Independent Disks (RAID), Just a Bunch of Disks (JBOD), etc., a tape device, an optical disk device, a non-volatile electronic memory device (e.g., Flash Disk), etc.

In one embodiment, the target file system 18 replicates the backed-up source directories and files 10, such that the target directories and files 16 are in the native file format of the corresponding source directories and files 10 backed-up. Thus, the target files 16 may be directly accessed by the applications that created the files.

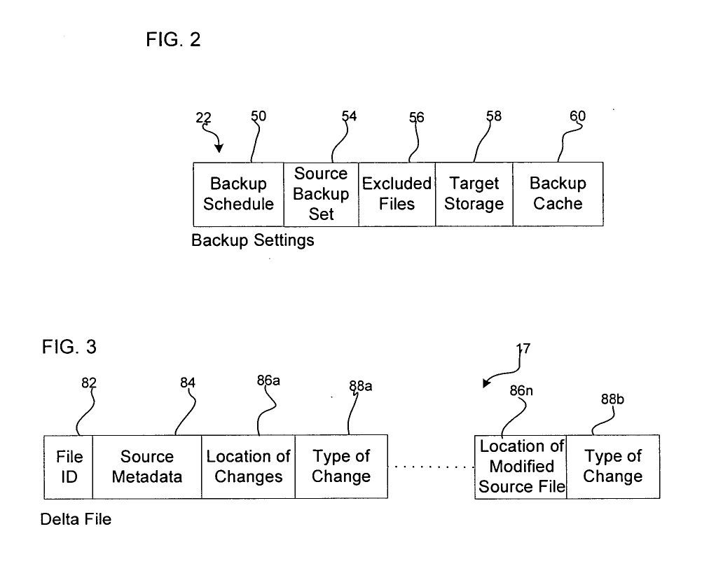

FIG. 2 illustrates an embodiment of information that may be included in the backup settings, including: a backup schedule 50 indicating times during which a backup operation occurs to write backed-up files to the target storage 20; a source backup set 54 indicating the source directories and files 10 to include in the backup, which may comprise a directory path or an entire logical device, e.g., the “c” drive; excluded files 56 indicating files, directories and/or file types in the source file system 12 to exclude from the backup; a target storage 58 indicating the device or directory location in a device to which the source files are replicated; a backup cache 60 indicating the device or directory location of the backup cache 24 to which files are backed-up; and a version space limit 62 indicating a maximum amount of storage space allocated to the backup cache 24 to store backed up files and different versions of files

FIG. 3 illustrates an embodiment of a delta file 17, comprising the delta file 17a in the backup cache 24 or the delta file 17b maintained at the target storage 20. The delta file 17 is computed by comparing the differences of a modified source file with the base copy 25 of that source file. The delta file 17 may have a name including the name of the source file from which it is computed and a version identifier or other timestamp to distinguish the created delta file from delta files previously created for the source file. The backup extension 32 creates a delta file 17a in response to a request to modify a source file, such as such as a write or delete, prior to the modification. The delta file 17 includes an identifier 82 and metadata 84 providing information on the source file from which the changes were calculated. The metadata 84 may indicate the location of the source file in the source file system 12, i.e., the path and file name.

In one embodiment, when the backup program 8 wants to transmit the changes to the target location 20, the backup program 8 creates a new delta file 17a for the source file, determines the differences or changes of the modified source file over the base copy 25 and indicates a location of the changes 86a . . . 86n (deleted, updated or added) in the source file 86a . . . 86n and the type of change 88a . . . 88n, such as deletion, update, or addition, being made during the current modification. Once the delta file 17a is transmitted to the target storage 20, the delta file 17a and base file 25 from which the delta file 17a was created may be deleted to clean up the backup cache 24. The delta file 17a may be stored in the backup cache 24 as shown in FIG. 1. Thus, in the embodiment of FIG. 3, the delta file 17 indicates the location of the changes and the type of change in the source file. If data is deleted, then the location of modified source data 86a . . . 86n indicates those blocks removed from the file. The backup program 8 transfers the delta file 17a to the target storage 20 for storage in the target file system 18 as delta file 17b.

In one embodiment, the backup program 8 may issue a file system write operation to apply differences between the source file and base copy 25. In such embodiments, the delta file 17a or 17b is not created or maintained, because the determined differences are applied directly to the target file in the target storage location 20. The write operation may be executed by the file system 30 if the target storage 20 is local with respect to the computer 2. Alternatively, if the target storage 20 is managed by a machine remote with respect to the computer 2, then the backup program 8 communicates the write operation over a network to the target location using techniques known in the art for communicating file system operations over a network.

After information on the changes, i.e., deltas, are transmitted to the target storage 20, to either be stored in delta file 17b or immediately applied to the target file, the base copy 25 and any existing delta files 17a created from that base copy may be deleted. After deletion, a new base copy 25 and delta file 17a are created in response to further modifications of the source file after synchronization with the target.

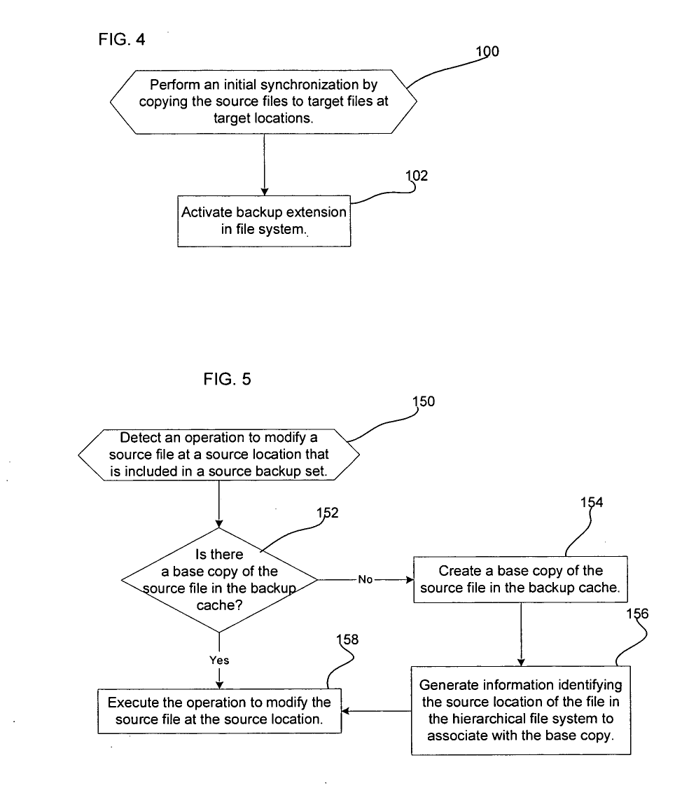

FIG. 4 illustrates operations implemented in the backup program 8 to initiate backup operations for a source backup set 54. The backup program 8 performs (at block 100) an initial synchronization by copying the source files and directories 10 to the target files and directories 16 so that the target file system 18 mirrors the source directories and files 10 specified in the source backup set 54 and excluded files 56. The backup program 8 may also make sure (at block 102) that the backup extension 32 is activated in the file system 30 to monitor operations to modify source files in a backup set 54. If there are not active backup sets, then the backup extension 32 may be disabled so as not to interfere with file system 30 operations.

FIG. 5 illustrates an embodiment of operations performed by the backup extension 32 to maintain base copies 25 of source files in a backup set 54. Control begins at block 150 when the backup extension 32 detects an operation, such as a write or delete, to modify a source file at a source location 10 that is included in an active source backup set 54. The backup extension 32 determines (at block 152) whether there is a base copy 25 of the source file in the backup cache 24. If not, then the backup extension 32 creates (at block 154) a base copy 25 of the source file in the backup cache 24 and generates (at block 156) information identifying the source location (path and file name) of the source file in the hierarchical file system 12 to associate with the base copy 80. In the embodiment of FIG. 5, the base copy 25 comprises a full copy of the about-to-be modified file. If there is already a base copy 25 (from block 152) or after creating a base copy 25 (at block 156), the backup extension 32 allows (at block 158) the intercepted file operation to modify the source file to proceed.

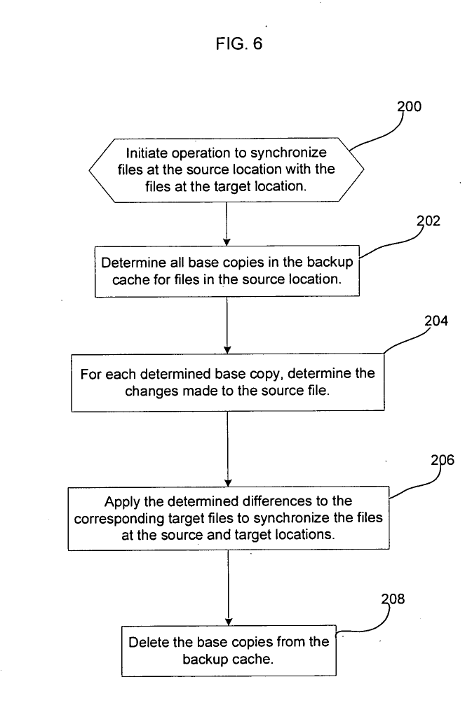

FIG. 6 illustrates an embodiment of operations performed by the backup program 8 to perform a synchronization of the source files identified in the source backup set 54 to the target storage 20. Upon initiating (at block 200) the synchronization operation, the backup program 8 determines (at block 202) all base copies 25 in the backup cache 24 for files in the source location identified in one active backup set 54. For each determined base copy 25, the backup program 8 determines (at block 204) the changes made to the source file since the base copy 25 was created. In one embodiment, the backup program 8 applies (at block 206) the determined differences, i.e., the changed data, deletions or additions to the source file to the target file copy in the target storage 20. The backup program 8 may apply the changes by issuing write or delete commands to the file system managing access to the target storage 20, which may be the file system 30 if the target storage 20 is attached to the computer 2 or a file system on a remote machine (not shown) managing the target storage 20. The backup program 8 then deletes (at block 208) the base copies 25 from the backup cache 24.

In the embodiment of FIG. 6, only the specific changes are applied to the target file to conserver transfer bandwidth. Further, in the embodiment of FIG. 6, a delta file 17a, 17b is not maintained.

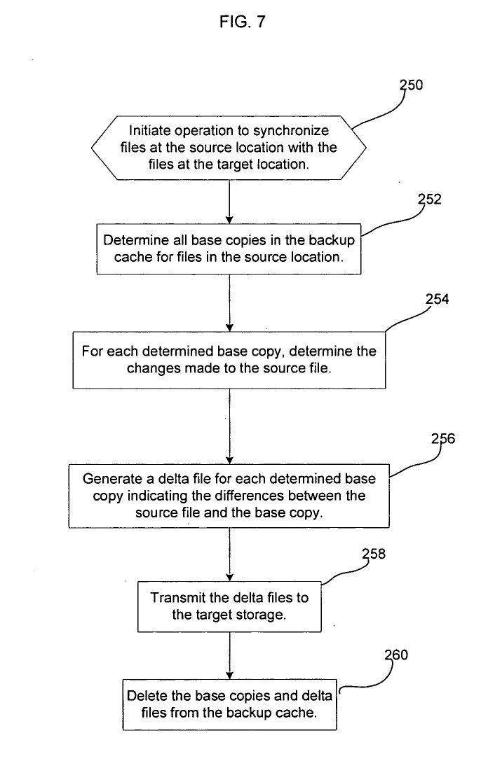

FIG. 7 illustrates an alternative embodiment of the synchronization operations of FIG. 6 where the changes are transmitted to the target storage 20 in the form of the delta file 17a. Blocks 250, 252, and 254 in FIG. 7 are the same as blocks 200, 202, and 204 in FIG. 7. However, upon determining (at block 254) the changes made to the source file by comparison of the source file and the base copy 25, the backup program 8 generates (at block 256) a delta file 17a (FIG. 3) indicating differences between a source file and the base copy 25. The generated delta file 17a is then transferred (at block 258) to the target storage 20 to store as delta file 17b with the target file corresponding to the source file from which the delta file was calculated. The backup program 8 deletes (at block 258) the base copies 25 and delta files 17a from the backup cache 24 after synchronization.

In certain embodiments, there may be multiple delta files 17b maintained for one target file. The user of the backup program 8 may then obtain the changes as of the point-in-time one of the delta files 17b was created by combining the delta file 17b and all previously created delta files with the target file, such that modifications are applied in an order from the earliest to the most current.

With the described embodiments, if a source file changes multiple times, then the updates can be determined by comparison of the source file and base copy, and the determined changes are only transferred at specific synchronization times, so that the backup program does not have to continually transfer data to the target storage in response to each change. Moreover, the synchronization may be scheduled during a time of minimal usage of the computer 2. The described embodiments may be useful if a user is modifying files while not having access to the target storage 20, such as the case if the target storage 20 is normally accessible over a network to which the user does not currently have access. In such case, all changes will be capable of being determined from the source file information in the backup cache 24, and the synchronization performed when the user reconnects to the target storage 20. Further, with certain described embodiments, the base copy is only maintained for source files that have been modified to conserve space in the backup cache to store base copies used to determine changes.

### Additional Embodiment Details

The described operations may be implemented as a method, apparatus or article of manufacture using standard programming and/or engineering techniques to produce software, firmware, hardware, or any combination thereof. The term “article of manufacture” as used herein refers to code or logic implemented in a medium, where such medium may comprise hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The computer readable medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

In certain embodiments, the file sets and metadata are maintained in separate storage systems and commands to copy the file sets and metadata are transmitted by systems over a network. In an alternative embodiment, the file sets and metadata may be maintained in a same storage system and the command to copy may be initiated by a program in a system that also directly manages the storage devices including the file sets and metadata to copy.

The illustrated operations of FIGS. 4, 5, 6, and 7 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

FIGS. 2 and 3 provide embodiments of information included in backup settings 22 and a delta file 17. In alternative embodiments, the backup settings and delta files may include different or additional information.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method, comprising:
detecting an operation to modify a source file at a source location, wherein a target file at a target location includes a copy of a version of the source file;
creating a base copy of the source file;
executing the operation to modify the source file after creating the base copy;
determining differences between the source file and the base copy of the file; and
transmitting the determined differences to the target location, wherein an aggregation of the target file and the transmitted determined differences comprises the modified source file.

2. The method of claim 1, further comprising:
deleting the base copy for the source file in response to transmitting the determined differences to the target location.

3. The method of claim 1, wherein there are a plurality of target files at the target location maintained for source files at the source location, wherein base copies are not created for source files that have not been modified.

4. The method of claim 1, further comprising:
determining whether there is the base copy of the source file in response to detecting the operation to modify the file at the source location, wherein the base copy is created in response to determining that there is no base copy for the source file.

5. The method of claim 1, wherein the source location is included in a first directory of a hierarchical file system, and wherein the base copy is stored in a second directory of the file system, further comprising:
generating information identifying the source location of the source file in the first directory to associate with the base copy in response to creating the base copy.

6. The method of claim 5, wherein the information identifying the location of the file in the first directory comprises:
creating a hierarchical directory structure in the second directory mirroring the hierarchical directory structure including the first directory.

7. The method of claim 1, wherein the operations of detecting the operation to modify the source file, creating the base copy, executing the operation to modify after creating the base copy, and determining the differences are performed with respect to a plurality of source files at source locations, wherein there are target files at target locations comprising copies of the source files, further comprising:
initiating an operation to synchronize the source files with target files; and
determining base copies created for source files in the source location, wherein the operation of determining the differences between the file at the source location and the base copy is performed for each determined base copy, and wherein the determined differences for each determined base copy are transmitted to the target location to synchronize the source and target locations.

8. The method of claim 7, further comprising:
performing an initial synchronization by copying the source files to target files at the target locations before initiating operations to synchronize files by determining differences between the base copy and the file at the source location.

9. The method of claim 1, wherein the operations of detecting the operation to modify the source file, creating the base copy, and executing the operation to modify after creating the base copy are implemented in code integrated with file system code that executes in a kernel mode.

10. The method of claim 1, wherein the transmitted differences are applied to the target file at the target location to produce a modified target file having the same data as the modified source file.

11. The method of claim 1, wherein the transmitted differences for the source file are stored at the target location in a delta file that when combined with the target file produce the modified source file.

12. A system, comprising:
a processor;
a source location;
a target location;
code executed by the processor to perform operations, the operations comprising:
detecting an operation to modify a source file at the source location, wherein a target file at the target location includes a copy of a version of the source file;
creating a base copy of the source file;
executing the operation to modify the source file after creating the base copy;
determining differences between the source file and the base copy of the file; and
transmitting the determined differences to the target location, wherein an aggregation of the target file and the transmitted determined differences comprises the modified source file.

13. The system of claim 12, wherein the operations further comprise:
deleting the base copy for the source file in response to transmitting the determined differences to the target location.

14. The system of claim 12, wherein the operations further comprise:
determining whether there is the base copy of the source file in response to detecting the operation to modify the file at the source location, wherein the base copy is created in response to determining that there is no base copy for the source file.

15. The system of claim 12, further comprising:
a file system executing in a kernel mode, wherein the operations of detecting the operation to modify the source file, creating the base copy, and executing the operation to modify after creating the base copy are implemented in extension code integrated with file system code executing in the kernel mode.

16. The system of claim 12, wherein the transmitted differences for the source file are stored at the target location in a delta file that when combined with the target file produce the modified source file.

17. An article manufacture including code executed to communicate with a source and target locations and to perform operations, the operations comprising:
detecting an operation to modify a source file at the source location, wherein a target file at the target location includes a copy of a version of the source file;
creating a base copy of the source file;
executing the operation to modify the source file after creating the base copy;
determining differences between the source file and the base copy of the file; and
transmitting the determined differences to the target location, wherein an aggregation of the target file and the transmitted determined differences comprises the modified source file.

18. The article of manufacture of claim 17, wherein the operations further comprise:
deleting the base copy for the source file in response to transmitting the determined differences to the target location.

19. The article of manufacture of claim 17, wherein there are a plurality of target files at the target location maintained for source files at the source location, wherein base copies are not created for source files that have not been modified.

20. The article of manufacture of claim 17, wherein the operations further comprise:
determining whether there is the base copy of the source file in response to detecting the operation to modify the file at the source location, wherein the base copy is created in response to determining that there is no base copy for the source file.

21. The article of manufacture of claim 17, wherein the source location is included in a first directory of a hierarchical file system, and wherein the base copy is stored in a second directory of the file system, further comprising:
generating information identifying the source location of the source file in the first directory to associate with the base copy in response to creating the base copy.

22. The article of manufacture of claim 21, wherein the information identifying the location of the file in the first directory comprises:
creating a hierarchical directory structure in the second directory mirroring the hierarchical directory structure including the first directory.

23. The article of manufacture of claim 17, wherein the operations of detecting the operation to modify the source file, creating the base copy, executing the operation to modify after creating the base copy, and determining the differences are performed with respect to a plurality of source files at source locations, wherein there are target files at target locations comprising copies of the source files, wherein the operations further comprise:
initiating an operation to synchronize the source files with target files; and
determining base copies created for source files in the source location, wherein the operation of determining the differences between the file at the source location and the base copy is performed for each determined base copy, and wherein the determined differences for each determined base copy are transmitted to the target location to synchronize the source and target locations.

24. The article of manufacture of claim 23, wherein the operations further comprise:
performing an initial synchronization by copying the source files to target files at the target locations before initiating operations to synchronize files by determining differences between the base copy and the file at the source location.

25. The article of manufacture of claim 17, wherein the operations of detecting the operation to modify the source file, creating the base copy, and executing the operation to modify after creating the base copy are implemented in file system extension code integrated with file system code executing in the kernel mode and wherein the operations to determine the differences and transmit the determined differences are performed by a backup program.

26. The article of manufacture of claim 17, wherein the transmitted differences are applied to the target file at the target location to produce a modified target file having the same data as the modified source file.

27. The article of manufacture of claim 17, wherein the transmitted differences for the source file are stored at the target location in a delta file that when combined with the target file produce the modified source file.
